(19) United States
(12) Patent Application Publication
(10) Pub. No.: US 2013/0221883 A1
(43) Pub. Date: Aug. 29, 2013

(54) MOTOR DRIVING CIRCUIT, MOTOR DRIVING APPARATUS HAVING THE SAME, AND MOTOR DRIVING METHOD

(71) Applicant: Samsung Electro-Mechanics Co., Ltd., (US)

(72) Inventor: Bon Young Gu, Gyeonggi-do (KR)

(73) Assignee: SAMSUNG ELECTRO-MECHANICS CO., LTD., Gyeonggi-do (KR)

(21) Appl. No.: 13/773,541

(22) Filed: Feb. 21, 2013

(30) Foreign Application Priority Data
Feb. 29, 2012 (KR) 10-2012-0021017

(51) Int. Cl. H02P 6/08

(52) U.S. Cl. CPC H02P 6/08
USPC 318/400.13

(57) ABSTRACT

Disclosed herein is a motor driving circuit including: a duty ratio detection unit that detects a duty ratio of input pulse-width-modulation applied to control a speed of a motor; and a driving control unit that detects an output duty ratio corresponding to the duty ratio of the input pulse-width-modulation by using relationship data between the duty ratio of the input pulse-width-modulation and an output duty ratio that are previously stored and controls a duty ratio of a driving signal applied to the motor according to the output duty ratio. By this configuration, a speed of the motor can be accurately controlled.

### CROSS REFERENCE(S) TO RELATED APPLICATIONS

This application claims the benefit under 35 U.S.C. Section 119 of Korean Patent Application Serial No. 10-2012-0021017, entitled “Motor Driving Circuit, Motor Driving Apparatus Having The Same, And Motor Driving Method” filed on Feb. 29, 2012, which is hereby incorporated by reference in its entirety into this application.

### BACKGROUND OF THE INVENTION

1. Technical Field

The present invention relates to a motor driving circuit capable of controlling a motor at a desired speed, a motor driving apparatus having the same, and a motor driving method.

2. Description of the Related Art

Generally, a motor means a device that is used in various fields from home appliances such as a refrigerator, an air conditioner, or the like, to an information processing device such as a disk driver. A motor capable of controlling speed such as a brushless direct current (BLDC) motor can control speed by controlling a duty ratio of a pulse-width-modulation (PWM) signal.

Meanwhile, a speed control scheme of a motor may be largely classified into a closed loop control scheme and an open loop control scheme. The closed loop control scheme includes a feedback circuit to detect current revolution per minute (RPM), speed, and surrounding operating environments, or the like, of the motor and controls an input signal from the detection to control errors occurring during the operation of the motor. However, the speed control scheme needs to further include a circuit for detecting the current RPM, speed, or the like, of the motor, a voltage detection circuit and an error compensation circuit for coping with external operating environments, or the like, which leads to an increase in complexity of a circuit.

On the other hand, the open control scheme does not include the feedback circuit and therefore, may be implemented with a simple structure, but cannot compensate for errors occurring due to external operating environments such as a change in voltage, temperature, or the like.

### RELATED ART DOCUMENT

Korean Patent Laid-Open Publication No. 2006-0070257

### SUMMARY OF THE INVENTION

An object of the present invention is to provide a motor driving circuit capable of accurately controlling a speed of a motor according to external operating environments without adding or changing separate circuits by using relationship data between a duty ratio of input pulse-width-modulation and an output duty ratio that are stored in the motor driving circuit, a motor driving apparatus having the same, and a motor driving method.

According to an exemplary embodiment of the present invention, there is provided a motor driving circuit, including: a duty ratio detection unit that detects a duty ratio of input pulse-width-modulation applied to control a speed of a motor; and a driving control unit that detects an output duty ratio corresponding to the duty ratio of the input pulse-width-modulation by using relationship data between the duty ratio of the input pulse-width-modulation and an output duty ratio that are previously stored and controls a duty ratio of a driving signal applied to the motor according to the output duty ratio.

The motor driving circuit may further include: a storage unit in which the relationship data between the duty ratio of the input pulse-width-modulation and the output duty ratio are stored.

The storage unit may store the relationship data between the duty ratio of the input pulse-width-modulation and the output duty ratio in a look up table form.

The storage unit may store the relationship data between the duty ratio of the input pulse-width-modulation and the output duty ratio in a linear function form of the output duty ratio with respect to the duty ratio of the input pulse-width-modulation.

The linear function of the output duty ratio with respect to the duty ratio of the input pulse-width-modulation may be represented by the following <Equation>.

<Equation>

Output duty ratio=Duty ratio of input pulse-width-modulation Slope a+Constant b,

where b is a minimum value of the output duty ratio.

The storage unit may store the relationship data between the duty ratio of the input pulse-width-modulation and the output duty ratio in a form in which the look up table and the linear function of the output duty ratio with respect to the duty ratio of the input pulse-width-modulation are combined with each other.

The relationship data between the duty ratio of the input pulse-width-modulation and the output duty ratio may be configured in a form in which a plurality of linear functions having different slopes for each section of the duty ratio of the input pulse-width-modulation are combined with one another.

The driving control unit may control the duty ratio of the driving signal applied to the motor to be equal to the output duty ratio and control a driving of the motor according to the duty ratio of the driving signal.

The driving control unit may include: a detector that detects the output duty ratio corresponding to the duty ratio of the input pulse-width-modulation by using the relationship data between the duty ratio of the input pulse-width-modulation and the output duty ratio; a controller that controls the duty ratio of the driving signal applied to the motor by using the detected output duty ratio; and a driver that controls the driving of the motor according to the duty ratio of the driving signal.

According to another exemplary embodiment of the present invention, there is provided a motor driving apparatus, including: an external control circuit that generates and outputs input pulse-width-modulation as a command for controlling a motor at a desired speed; and a motor driving circuit that receives the input pulse-width-modulation to detect a duty ratio of the input pulse-width-modulation, detects an output duty ratio corresponding to the duty ratio of the input pulse-width-modulation by using relationship data between the input pulse-width-modulation and the output duty ratio that are previously stored, and controls a duty ratio of a driving signal applied to the motor according to the output duty ratio.

The motor driving circuit may include a storage unit in which the relationship data between the duty ratio of the input pulse-width-modulation and the output duty ratio are stored.

The storage unit may store the relationship data between the duty ratio of the input pulse-width-modulation and the output duty ratio in a look up table form.

The storage unit may store the relationship data between the duty ratio of the input pulse-width-modulation and the output duty ratio in a linear function form of the output duty ratio with respect to the duty ratio of the input pulse-width-modulation.

The linear function of the output duty ratio with respect to the duty ratio of the input pulse-width-modulation may be represented by the following <Equation>.

<Equation>Output duty ratio=Duty ratio of input pulse-width-modulation×Slope a+Constant b,

where b is a minimum value of the output duty ratio.

The storage unit may store the relationship data between the duty ratio of the input pulse-width-modulation and the output duty ratio in a form in which the look up table and the linear function of the output duty ratio with respect to the duty ratio of the input pulse-width-modulation are combined with each other.

The relationship data between the duty ratio of the input pulse-width-modulation and the output duty ratio may be configured in a form in which a plurality of linear functions having different slopes for each section of the duty ratio of the input pulse-width-modulation are combined with one another.

The driving control unit may control the duty ratio of the driving signal applied to the motor to be equal to the output duty ratio and control a driving of the motor according to the duty ratio of the driving signal.

According to another exemplary embodiment of the present invention, there is provided a motor driving method, including: detecting a duty ratio of input pulse-width-modulation applied to control a speed of a motor; detecting an output duty ratio corresponding to the duty ratio of the input pulse-width-modulation by using relationship data between the duty ratio of the input pulse-width-modulation and an output duty ratio that are previously stored; controlling a duty ratio of a driving signal applied to the motor according to the output duty ratio; and controlling a driving of the motor according to the duty ratio of the driving signal.

At the controlling of the duty ratio of the driving signal, the duty ratio of the driving signal applied to the motor may be controlled to be equal to the output duty ratio to control the driving of the motor.

The relationship data between the duty ratio of the input pulse-width-modulation and the output duty ratio may be stored in a look up table form, and be stored in a linear function form of the output duty ratio with respect to the duty ratio of the input pulse-width-modulation.

### BRIEF DESCRIPTION OF THE DRAWINGS

FIG. 1 is a schematic configuration diagram of a motor driving apparatus in accordance with an exemplary embodiment of the present invention.

FIG. 2 is a detailed configuration diagram of the motor driving circuit shown in FIG. 1.

FIGS. 3A and 3B are diagrams showing relationship data stored in a storage unit of FIG. 2 in a look-up table form.

FIG. 3A is a diagram showing an output duty ratio corresponding to a duty ratio of input pulse-width-modulation.

FIG. 3B is a diagram showing an output duty ratio corresponding to an address.

FIGS. 4A to 4D are diagrams showing the relationship data stored in the storage unit of FIG. 2 in a linear function form.

FIG. 4A is a diagram showing a relationship graph between the duty ratio of the input pulse-width-modulation and the output duty ratio.

FIG. 4B is a diagram showing information stored in the storage unit of FIG. 2.

FIGS. 4C and 4D are diagrams showing various examples of a relationship graph between the duty ratio of the input pulse-width-modulation and the output duty ratio.

FIGS. 5A to 5C are diagrams showing the relationship data stored in the storage unit of FIG. 2 by a combination of a look-up table form and a linear function form.

FIG. 6A is a diagram showing the relationship graph between the duty ratio of the input pulse-width-modulation and the motor speed when a driving signal corresponding to the duty ratio of the input pulse-width-modulation is directly applied to the motor.

FIG. 6B is a diagrams showing the relationship graph between the duty ratio of the input pulse-width-modulation and the motor speed in accordance with the embodiment of the present invention.

FIG. 7 is an operational flow chart showing a motor driving process in accordance with the exemplary embodiment of the present invention.

### DESCRIPTION OF THE PREFERRED EMBODIMENTS

Terms or words used in the specification and the appended claims should not be construed as normal and dictionary meanings and should be construed as meanings and concepts which conform with the spirit of the present invention according to a principle that the inventor can properly define the concepts of the terms in order to describe his/her own invention in the best way.

Accordingly, embodiments disclosed in the specification and configurations shown in the accompanying drawings are just the most preferred embodiment, but are not limited to the spirit and scope of the present invention. Therefore, at this application time, it will be appreciated that various equivalents and modifications may be included within the spirit and scope of the present invention.

Hereinafter, exemplary embodiments of the present invention will be described in detail with reference to the accompanying drawings.

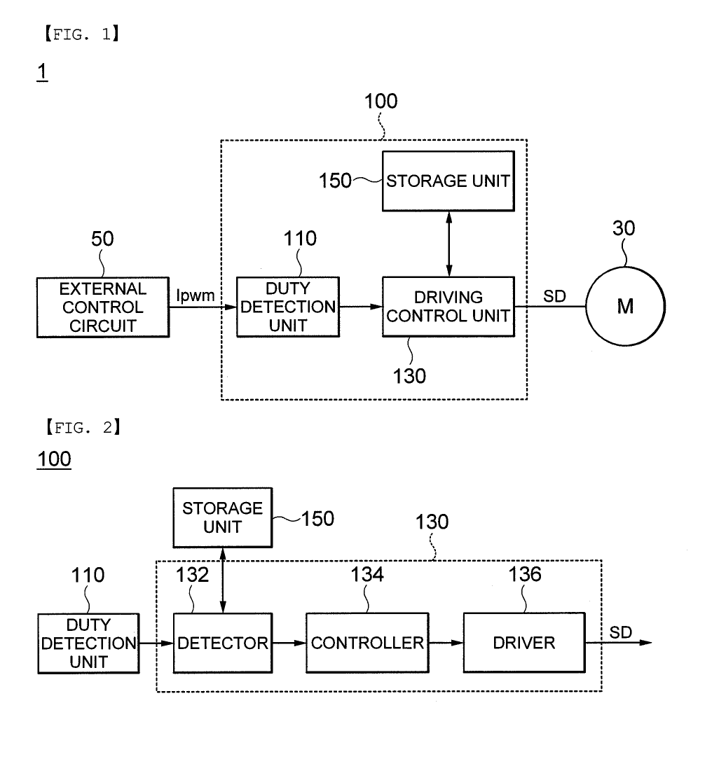

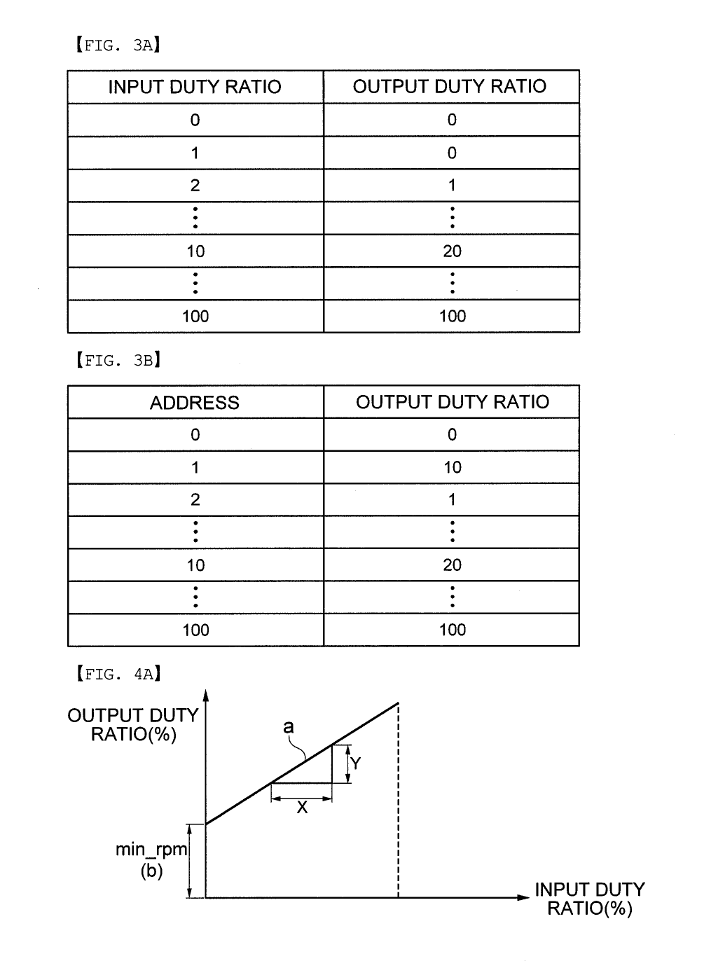

FIG. 1 is a schematic configuration diagram of a motor driving apparatus in accordance with an exemplary embodiment of the present invention and FIG. 2 is a detailed configuration diagram of the motor driving circuit shown in FIG. 1.

As shown in FIGS. 1 and 2, a motor driving apparatus 1 is configured to include an external control circuit 50 and a motor driving circuit 100.

First describing a motor, a motor 30 may be a brushless direct current (BLDC) motor, or the like. The BLDC motor is a brushless motor among direct current (DC) motors, wherein a rotator may be configured of a permanent magnet and a stator at the outside of the motor may be configured of an electromagnet.

The external control circuit 50 is a unit that generates input pulse-width-modulation that is a command for controlling the motor 30 at a desired speed and transmits the generated input pulse-width-modulation to the motor driving circuit 100. In this case, the input pulse-width-modulation Ipwm is generated regardless of driving environment of the motor and thus, the motor is not affected by a change in external operating environments such as a change in temperature, or the like.

The motor driving circuit 100, which is a unit of controlling the motor 30 at a desired speed, is configured to include a duty detection unit 110, a driving control unit 130, and a storage unit 150.

The duty detection unit 110, which is a unit of detecting a duty ratio of the input pulse-width-modulation Ipwm, detects turn-on time at which a signal has a high value within one period of the input pulse-width-modulation Ipwm and turn-off time at which the input pulse-width-modulation Ipwm is a low value, thereby detecting the duty ratio of the input pulse-width-modulation Ipwm.

In other words, the duty detection unit 110 can detect the duty ratio of the input pulse-width-modulation Ipwm that is a ratio of the turn-on time having the high value within one period of the input pulse-width-modulation-signal Ipwm from a period of the input pulse-width-modulation Ipwm and the timing having the high value.

The driving control unit 130, which is a microcomputer that generally controls the motor driving circuit 100, is configured to include a detector 132, a controller 134, and a driver 136.

Among others, the detector 132 detects the output duty ratio corresponding to the duty ratio of the input pulse-width-modulation Ipwm by using relationship data between the duty ratio of the input pulse-width-modulation Ipwm and the output duty ratio that are stored in the storage unit 150.

That is, the detector 132 can read the output duty ratio corresponding to the duty ratio of the input pulse-width-modulation Ipwm by referring to corresponding relationship between the duty ratio of the input pulse-width-modulation Ipwm and the output duty ratio that are previously stored in a data table, or the like, or can detect the output duty ratio according to the duty ratio of the input pulse-width-modulation Ipwm by performing direct operation according to a specific formula.

In this case, the output duty ratio, which is a duty ratio of a signal output from the motor driving circuit 100, means a duty ratio of a driving signal (SD) that is output from the motor driving circuit 100 and is applied to the motor 30.

Describing in detail the storage unit 150 prior to describing an operation of the detector 132, the storage unit 150 is a unit in which the relationship data between the duty ratio of the input pulse-width-modulation Ipwm and the output duty ratio are stored and may be configured to include a volatile memory or a non-volatile memory. In addition, the storage unit 150 may be configured of a flip flop. In this case, the flip flop, which is a memory used for a sequential logic circuit, may be configured to determine an output in response to a clock signal.

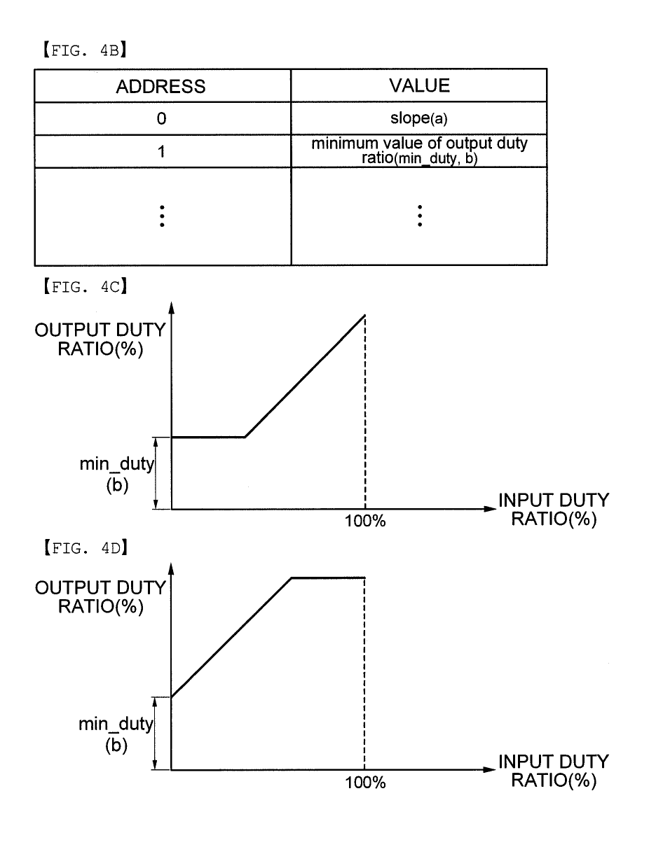

FIGS. 3A and 3B are diagrams showing the relationship data stored in the storage unit of FIG. 2 in a look-up table form.

Referring to FIG. 3A, the storage unit 150 may store the relationship data between the duty ratio of the input pulse-width-modulation Ipwm and the output duty ratio in the look up table form. For example, when 101 duty ratios of the input pulse-width-modulation Ipwm from 0 to 100% are stored, 101 output duty ratios corresponding to the duty ratios of each input pulse-width-modulation Ipwm may be stored in a percentage (%) form.

Further, as shown in FIG. 3B, the storage unit 150 does not directly store the duty ratio of the input pulse-width-modulation Ipwm but the output duty ratio may be stored in an address corresponding to the duty ratio of the input pulse-width-modulation Ipwm.

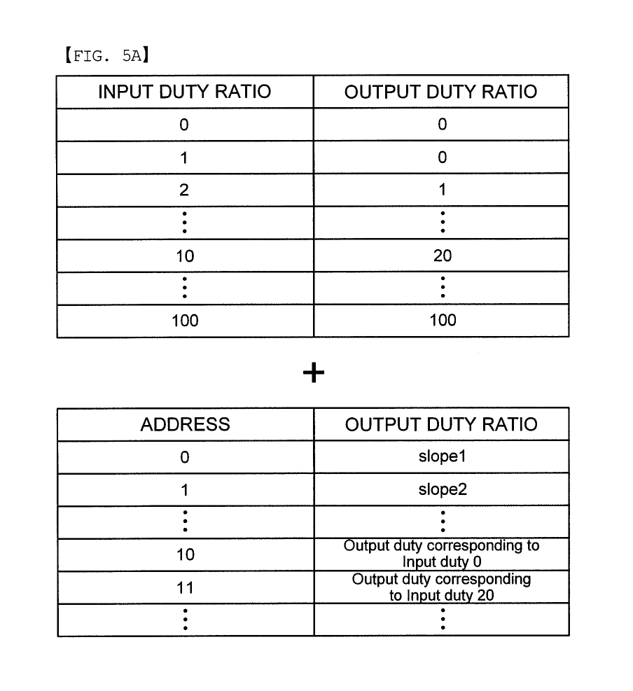

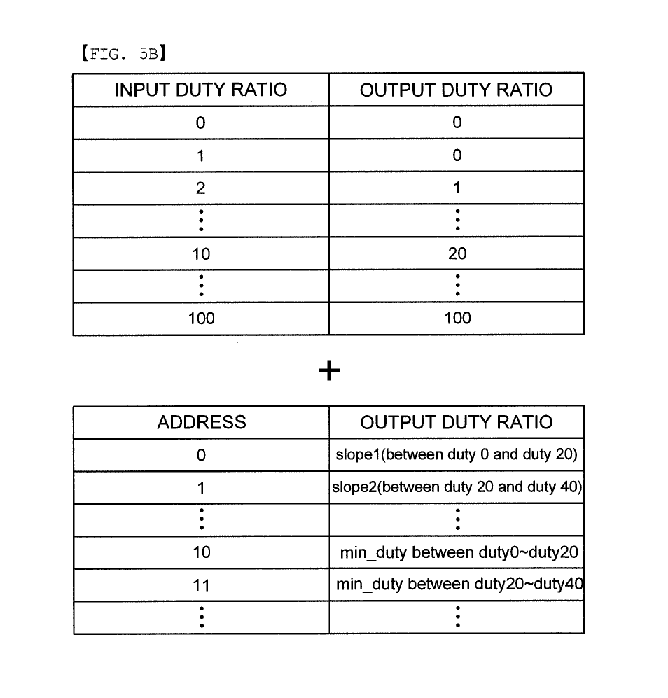

FIGS. 4A to 4D are diagrams showing the relationship data stored in the storage unit of FIG. 2 in a linear function form, wherein FIG. 4A is a diagram showing a relationship graph between the duty ratio of the input pulse-width-modulation and the output duty ratio. In this case, the storage unit 150 may store the output duty ratio with respect to the duty ratio of the input pulse-width-modulation Ipwm in a linear function form.

In this case, the linear function of the output duty ratio with respect to the duty ratio of the input pulse-width-modulation Ipwm may be represented by the following <Equation>.

<Equation>

Output duty ratio=Duty ratio of input pulse-width-modulation×Slope a+Constant b

In the above Equation, the slope a represents an increment Y of the output duty ratio/an increment X of the duty ratio of the input pulse-width-modulation and the constant b represents a minimum value min duty of the output duty ratio.

As such, in order to detect the output duty ratio corresponding to the duty ratio of the input pulse-width-modulation Ipwm, the storage unit 150 may store the slope a and the minimum value b of the output duty ratio as shown in FIG. 4B and when the duty ratio of the input pulse-width-modulation Ipwm is detected, the current output duty ratio corresponding to the duty ratio of the input pulse-width-modulation Ipwm can be detected by using the slope a and the minimum value b of the output duty ratio that are stored in the storage unit 150.

FIGS. 4C and 4D are diagrams showing various examples of a relationship graph between the duty ratio of the input pulse-width-modulation and the output duty ratio. As shown in FIGS. 4C and 4D, the relationship graph, that is, the linear function of the output duty ratio with respect to the duty ratio of the input pulse-width-modulation Ipwm may be variously set according to the characteristics of the motor.

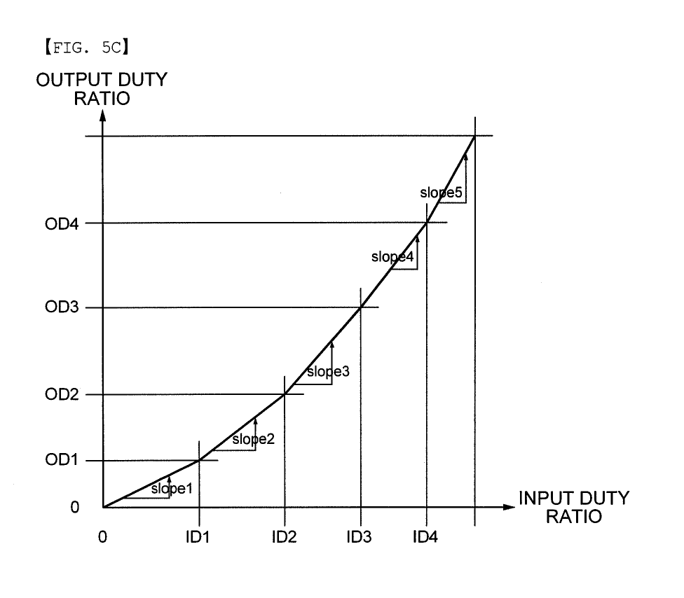

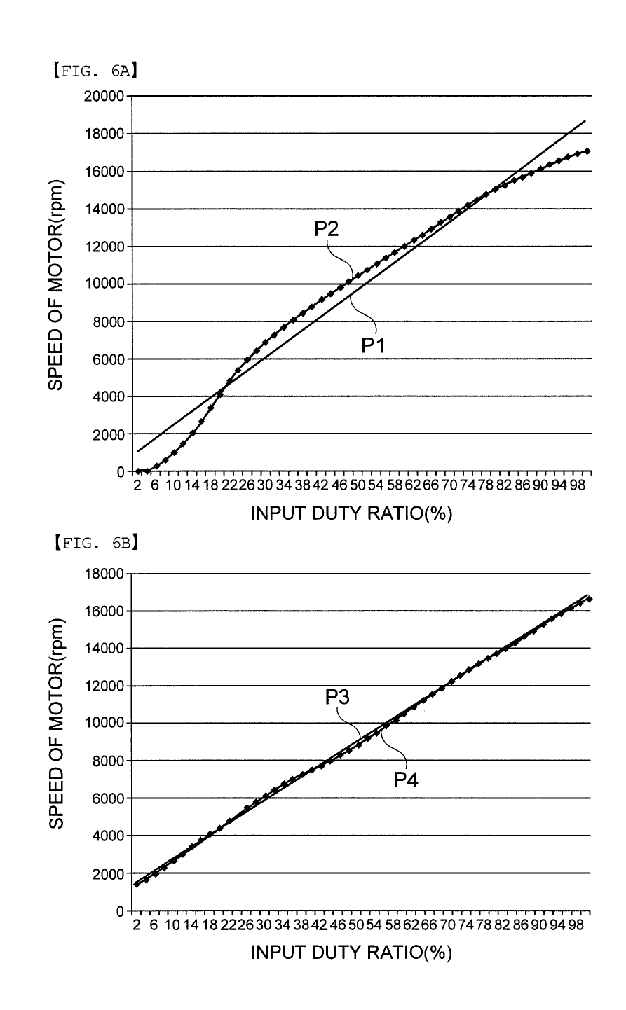

FIGS. 5A to 5C are diagrams showing the relationship data stored in the storage unit of FIG. 2 by a combination of a look-up table form and a linear function form. As shown in FIGS. 5A and 5B, the storage unit 150 may store the relationship data between the duty ratio of the input pulse-width-modulation Ipwm and the output duty ratio in a form in which the look up table and the linear function of the output duty ratio with respect to the duty ratio of the input pulse-width-modulation Ipwm are combined with each other.

In this case, at least two slopes and minimum values of the output duty ratio may be stored, but other values may be applied according to the duty ratio of the input pulse-width-modulation.

Describing in more detail with reference to FIG. 5C, the relationship data between the duty ratio of the input pulse-width-modulation and the output duty ratio may be configured in a form in which the plurality of linear functions having different slopes for each section of the duty ratio of the input pulse-width-modulation are combined with one another. For example, if a first duty ratio ID1 of the input pulse-width-modulation is 20, when the first duty ratio of the input pulse-width-modulation corresponds to a section of 0 to 20, a slope of slope 1 may be applied and if a second duty ratio ID2 of the input pulse-width-modulation is 45, when the second duty ratio of the input pulse-width-modulation corresponds to a section of 22 to 45, slope 2 may be applied. In this case, when the duty ratio of the input pulse-width-modulation is 22, results of Equation of section 1 and Equation of section 2 are the same, which may have a form of a continuous graph.

Further, the output duty ratio corresponding to the duty ratio of the input pulse-width-modulation Ipwm stored in the storage unit 150 can be controlled by measuring the duty ratio of the input-pulse-width modulation Ipwm and the speed characteristics of the motor.

In addition, the relationship data between the duty ratio Ipwm of the input pulse-width-modulation and the output duty ratio that are stored in the storage unit 150 may previously reflect the characteristics of the motor detected through an actual speed of the motor, characteristics of the motor driving circuit, and characteristics of other circuits.

Describing in more detail, the motor driving circuit 100 detects the actual speed of the motor to detect the characteristics of the motor and the characteristics of the motor driving circuit and previously reflects the detected characteristics to the relationship data between the duty ratio of the input pulse-width-modulation Ipwm and the output duty ratio to accurately control the speed of the motor according to the external operating environments without adding or changing the separate circuit.

Meanwhile, describing components of the driving control unit 130 referring again to FIG. 2, a controller 134 uses the output duty ratio detected by the detector 132 to control the duty ratio of the driving signal (SD) applied to the motor 30. In this case, the driving signal (SD) may be also generated in the pulse-width-modulation form. The controller 134 can control the duty ratio of the driving signal (SD) to be equal to the output duty ratio.

That is, the controller 134 may again generate the duty ratio of the driving signal (SD) according to the output duty ratio detected by the detector 132 at the time of generating the driving signal.

The driver 136 is a unit that uses the duty ratio of the driving signal (SD) to control the driving of the motor and, in more detail, controls an on/off operation of a plurality of switches that control a driving of the motor 30 according to the duty ratio of the driving signal (SD).

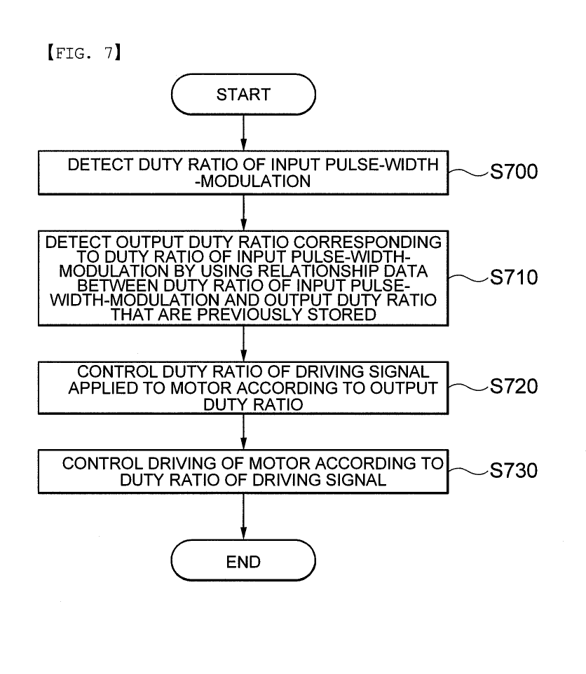

FIG. 6A is a diagram showing the relationship graph between the duty ratio of the input pulse-width-modulation and the motor speed when a driving signal corresponding to the duty ratio of the input pulse-width-modulation is directly applied to the motor and FIG. 6B is a diagrams showing the relationship graph between the duty ratio of the input pulse-width-modulation and the motor speed in accordance with the embodiment of the present invention.

As shown in FIG. 6A, when the duty ratio of the driving signal (SD) applied to the motor is controlled according to the duty ratio of the input pulse-width-modulation Ipwm (that is, when the driving signal (SD) having the same duty ratio as the duty ratio of the input pulse-width-modulation Ipwm is applied to the motor), it is difficult to control the characteristics of the motor or other components and therefore, it is impossible to control the motor 30 at a speed in a desired form. That is, as in P1, the duty ratio of the input pulse-width-modulation Ipwm may be linearly increased but the speed of the motor 30 may be non-linearly increased as in P2.

On the other hand, as shown in FIG. 6B, when the duty ratio of the driving signal (SD) is controlled according to the output duty ratio corresponding to the duty ratio of the input pulse-width-modulation Ipwm, as in P3, the duty ratio of the input pulse-width-modulation Ipwm is linearly increased and as in P4, the speed of the motor 30 is also linearly increased with respect to the duty ratio of the input pulse-width-modulation Ipwm.

Hereinafter, a process of driving the motor in accordance with the exemplary embodiment of the present invention will be described.

FIG. 7 is an operational flow chart showing a motor driving process in accordance with the exemplary embodiment of the present invention. Referring to FIG. 7, the duty ratio of the input pulse-width-modulation applied to control the speed of the motor is detected (S700).

Next, the detector 132 detects the output duty ratio corresponding to the duty ratio of the input pulse-width-modulation Ipwm by using relationship data between the duty ratio of the input pulse-width-modulation Ipwm and the output duty ratio that are previously stored (S710).

In this case, the output duty ratio corresponding to the duty ratio of the input pulse-width-modulation Ipwm can be read by referring to corresponding relationship between the duty ratio of the input pulse-width-modulation Ipwm and the output duty ratio that are previously prepared in the data table, or the like, or the output duty ratio according to the duty ratio of the input pulse-width-modulation Ipwm can be detected by performing the direct operation according to a specific formula.

Thereafter, the duty ratio of the driving signal (SD) applied to the motor is controlled according to the detected output duty ratio (S720). That is, the driving signal (SD) applied to the motor 30 is controlled to be the same duty ratio as the output duty ratio.

Next, the driving of the motor 30 is controlled according to the duty ratio of the driving signal (SD) (S730).

As set forth above, according to the motor driving circuit, the motor driving apparatus having the same, and the motor driving method in accordance with the exemplary embodiments of the present invention, the speed of the motor can be accurately controlled according to the external operating environments (voltage, load, or the like) without adding or changing separate circuits by using the relationship data between the duty ratio of the input pulse-width-modulation and the output duty ratio that are stored in the motor driving circuit.

Further, the motor driving apparatus including the motor driving circuit does not need to include the separate circuits or devices and therefore, the configuration thereof can be simplified.

Therefore, the manufacturing costs of the motor driving apparatus including the motor driving circuit can be saved.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. A motor driving circuit, comprising:
a duty ratio detection unit that detects a duty ratio of input pulse-width-modulation applied to control a speed of a motor; and
a driving control unit that detects an output duty ratio corresponding to the duty ratio of the input pulse-width-modulation by using relationship data between the duty ratio of the input pulse-width-modulation and an output duty ratio that are previously stored and controls a duty ratio of a driving signal applied to the motor according to the output duty ratio.

2. The motor driving circuit according to claim 1, further comprising a storage unit in which the relationship data between the duty ratio of the input pulse-width-modulation and the output duty ratio are stored.

3. The motor driving circuit according to claim 2, wherein the storage unit stores the relationship data between the duty ratio of the input pulse-width-modulation and the output duty ratio in a look up table form.

4. The motor driving circuit according to claim 2, wherein the storage unit stores the relationship data between the duty ratio of the input pulse-width-modulation and the output duty ratio in a linear function form of the output duty ratio with respect to the duty ratio of the input pulse-width-modulation.

5. The motor driving circuit according to claim 4, wherein the linear function of the output duty ratio with respect to the duty ratio of the input pulse-width-modulation is represented by the following <Equation>.
<Equation>
Output duty ratio=Duty ratio of input pulse-width-modulation×Slope a+Constant b,
where b is a minimum value of the output duty ratio.

6. The motor driving circuit according to claim 2, wherein the storage unit stores the relationship data between the duty ratio of the input pulse-width-modulation and the output duty ratio in a form in which the look up table and the linear function of the output duty ratio with respect to the duty ratio of the input pulse-width-modulation are combined with each other.

7. The motor driving circuit according to claim 5, wherein the relationship data between the duty ratio of the input pulse-width-modulation and the output duty ratio is configured in a form in which a plurality of linear functions having different slopes for each section of the duty ratio of the input pulse-width-modulation are combined with one another.

8. The motor driving circuit according to claim 1, wherein the driving control unit controls the duty ratio of the driving signal applied to the motor to be equal to the output duty ratio and controls a driving of the motor according to the duty ratio of the driving signal.

9. The motor driving circuit according to claim 1, wherein the driving control unit includes:
a detector that detects the output duty ratio corresponding to the duty ratio of the input pulse-width-modulation by using the relationship data between the duty ratio of the input pulse-width-modulation and the output duty ratio;
a controller that controls the duty ratio of the driving signal applied to the motor by using the detected output duty ratio; and
a driver that controls the driving of the motor according to the duty ratio of the driving signal.

10. A motor driving apparatus, comprising:
an external control circuit that generates and outputs input pulse-width-modulation as a command for controlling a motor at a desired speed; and
a motor driving circuit that receives the input pulse-width-modulation to detect a duty ratio of the input pulse-width-modulation, detects an output duty ratio corresponding to the duty ratio of the input pulse-width-modulation by using relationship data between the input pulse-width-modulation and the output duty ratio that are previously stored, and controls a duty ratio of a driving signal applied to the motor according to the output duty ratio.

11. The motor driving apparatus according to claim 10, wherein the motor driving circuit includes a storage unit in which the relationship data between the duty ratio of the input pulse-width-modulation and the output duty ratio are stored.

12. The motor driving apparatus according to claim 11, wherein the storage unit stores the relationship data between the duty ratio of the input pulse-width-modulation and the output duty ratio in a look up table form.

13. The motor driving apparatus according to claim 11, wherein the storage unit stores the relationship data between the duty ratio of the input pulse-width-modulation and the output duty ratio in a linear function form of the output duty ratio with respect to the duty ratio of the input pulse-width-modulation.

14. The motor driving apparatus according to claim 13, wherein the linear function of the output duty ratio with respect to the duty ratio of the input pulse-width-modulation is represented by the following <Equation>.
<Equation>
Output duty ratio=Duty ratio of input pulse-width-modulation×Slope a+Constant b,
where b is a minimum value of the output duty ratio.

15. The motor driving apparatus according to claim 11, wherein the storage unit stores the relationship data between the duty ratio of the input pulse-width-modulation and the output duty ratio in a form in which the look up table and the linear function of the output duty ratio with respect to the duty ratio of the input pulse-width-modulation are combined with each other.

16. The motor driving apparatus according to claim 14, wherein the relationship data between the duty ratio of the input pulse-width-modulation and the output duty ratio is configured in a form in which a plurality of linear functions having different slopes for each section of the duty ratio of the input pulse-width-modulation are combined with one another.

17. The motor driving apparatus according to claim 10, wherein the motor driving circuit controls the duty ratio of the driving signal applied to the motor to be equal to the output duty ratio and controls a driving of the motor according to the duty ratio of the driving signal.

18. A motor driving method, comprising:
detecting a duty ratio of input pulse-width-modulation applied to control a speed of a motor;
detecting an output duty ratio corresponding to the duty ratio of the input pulse-width-modulation by using relationship data between the duty ratio of the input pulse-width-modulation and an output duty ratio that are previously stored;
controlling a duty ratio of a driving signal applied to the motor according to the output duty ratio; and
controlling a driving of the motor according to the duty ratio of the driving signal.

19. The motor driving method according to claim 18, wherein at the controlling of the duty ratio of the driving signal, the duty ratio of the driving signal applied to the motor is controlled to be equal to the output duty ratio to control the driving of the motor.

20. The motor driving method according to claim 18, wherein the relationship data between the duty ratio of the input pulse-width-modulation and the output duty ratio are stored in a look up table form.

21. The motor driving method according to claim 18, wherein the relationship data between the duty ratio of the input pulse-width-modulation and the output duty ratio are stored in a linear function form of the output duty ratio with respect to the duty ratio of the input pulse-width-modulation.
